(19) United States
(12) Patent Application Publication
(10) Pub. No.: US 2016/0258542 A1
(43) Pub. Date: Sep. 8, 2016

(54) KINK VALVE ASSEMBLIES

(71) Applicant: Matthew Hoskins, Bend, OR (US)

(72) Inventor: Matthew Hoskins, Bend, OR (US)

(21) Appl. No.: 15/058,889

(22) Filed: Mar. 2, 2016

Related U.S. Application Data
(60) Provisional application No. 62/176,877, filed on Mar. 2, 2015.

(51) Int. Cl. F16K 7/06; F16K 23/00

(52) U.S. Cl. CPC F16K 7/068; F16K 23/00

(57) ABSTRACT

In one representative embodiment, a kink valve assembly comprises a first rigid member, a second rigid member pivotably coupled to the first rigid member, an elongate, flexible kink tube having first and second end portions, wherein the kink tube extends though the first and the second rigid members, a mouthpiece coupled to the first end portion of the kink tube, a first lock portion coupled to the first rigid member, a second lock portion coupled to the second rigid member, wherein the second lock portion is configured to releasably engage the first lock portion such that the first and the second rigid members cannot pivot relative to each other, and an actuator coupled to the first rigid portion or the second rigid portion, wherein the actuator is configured control the engagement of the first and the second lock portions.

### CROSS REFERENCE TO RELATED APPLICATION

This application claims the benefit of U.S. Provisional Application Ser. No. 62/176,877, entitled KINK VALVES, filed on Mar. 2, 2015, which is incorporated by reference herein.

### FIELD

The present disclosure relates to valves and, more particularly, to kink valves for hydration bladders.

### BACKGROUND

Various bite valves and valved mouthpieces exist for the purpose of drinking fluid from a reservoir in a controlled manner. These bite valves are typically featured in personal hydration systems worn by athletes, outdoors people, and military personnel to provide on-the-go hydration while exercising, recreating, or soldiering. The bite valve can connect to a drink tube that carries fluid from the reservoir. Bite valves can also be connected directly to the reservoir or a container such as a bottle.

Bite valves are normally sealed off and then open in response to external squeezing pressure. By placing the valve between one's teeth and biting down, the valve will open to allow drinking. There are a number of sealing mechanisms that can be employed to operate in the manner. Among these are slit type valves formed out of an elastomeric material such that deformation of the valve body causes the otherwise closed off slit to compress and form an opening. Another popular bite valve consists of an elastomeric tube mounted concentrically on a relatively rigid inner stem such that deformation of the tube breaks the seal between the tube and the stem allowing fluid flow. A similar type consists of an outer tube sealed against an internal spring-loaded stem such that biting forces advance or retract the stem to open the valve.

Bite valves are designed so that they are comfortable to bite and do not require excessive force to actuate. At the same time they must safeguard against inadvertent actuation and leaking. While most bite valves strike a successful balance between ease-of-operation and leak prevention on their own, it is often desirable to pair the bite valve with a manual shut-off valve that more fully prevents inadvertent fluid loss. The shut-off valve is located on the drink tube between the bite valve and reservoir and may be integrated with the bite valve or exist as a stand-alone component. Integration into an assembly with the bite valve is generally preferred as then, bite valve and shut-off are easily accessed by the user via their location at the end of the drink tube. Examples of bite valve shut-off mechanisms include stopcocks, trumpet valves, poppet-type valves, and others.

Among the desirable functional aspects of bite valve assemblies are robust fluid flow, ease-of-operation and cleanability. The structural requirements of shut-off mechanisms can reduce fluid flow rates. Furthermore, those with internal parts are difficult to clean and service.

As such, there is a continuing need for improved bite valves and/or shut-off assemblies.

### SUMMARY

Described herein are embodiments of kink valves and kink valve assemblies. In some embodiments, the kink valves can be used, for example, in a hydration assembly. In some embodiments, the kink valve assembly can include a foldable kink tube fluidly coupled to a bite valve and/or a drink tube of a hydration assembly (e.g., a hydration pack). The kink tube can be opened to allow fluid flow and can be folded to seal off flow of the fluid. In some embodiments, in the open position, the kink tube largely maintains its cross-sectional area; while in the folded position, the kink tube's collapsed walls press against one another to create a seal sufficient to withstand pressure levels to which a hydration system might be subjected. Therefore, fluid flow is not hampered by the kink tube when the kink valve assembly is in the open position, while shut-off is easily and reliably achieved.

In some embodiments, a kink valve assembly includes a mouthpiece (e.g., a bite valve) that is unitarily and fluidly coupled to a flexible, kink tube. The mouthpiece can include a valve that includes a normally closed outlet that opens in response to a mouth-actuated action. The kink tube can include an inlet that is coupled to and receives fluid from a fluid source (e.g., a bladder or reservoir). The outlet of the kink tube can be in fluidic communication with a flow channel extending from the inlet of the kink tube to the outlet of the kink tube.

The kink valve assembly can also include two or more adjustable, articulating rigid members that are pivotably coupled together. The rigid members can be coupled together, for example, via a hinge. The hinge can be configured so that it does not interfere with the kink tube. Various hinge designs may be employed to pivotably couple the rigid members including pin joints, living hinges, etc.

The rigid members can include an indexing mechanism such that the rigid members can be adjustably secured at one or more pre-determined positions relative to each other. The indexing mechanism can, for example, comprise tooth and gear configurations, ratchet-like designs, and/or various other mechanical means that releasably secure the positioning of the rigid members relative to each other.

In some embodiments, a kink valve assembly can be configured such that fluid flow is sealed off in the kink tube according to a desired relative positioning of the rigid members. For example, a kink valve assembly can be configured such that a mouthpiece portion of the kink tube can be offset by 90 degrees relative to a main portion of the kink tube. In some embodiments, the kink valve assembly can be configured such that when the rigid members form a right angle relative to each other, fluid can flow the kink tube. In such embodiments, shut-off can occur when the rigid members are folded towards each other, thereby causing the kink tube to kink or collapse against itself and thus preventing fluid from flowing through the kink tube.

In other embodiments, the kink valve assembly can be designed such that shut-off occurs when the rigid members are axially aligned relative to each other and/or when the kink tube is straightened.

In yet other embodiments, the kink valve assembly can allow flow through the kink tube when the mouthpiece is aligned with a drink tube. In such embodiments, the kink valve assembly can be configured such that shut-off occurs when the rigid members form a right angle relative to each other.

In some embodiments, the kink tube can be pre-formed to have an angled portion such that open flow and/or shut-off can occur at various pre-determined relative positions of the rigid members.

In some embodiments, the kink tube can be molded from an elastomeric material and can be formed as an extension of a mouthpiece (e.g., a bite valve). In some embodiments, the kink tube can be generally circular in cross section and of a size sufficient to allow full fluid flow through the kink tube when it is in the open position. The kink tube can be straight and/or angled. In some angled embodiments, the angled portion of the kink tube can be disposed at or near where the rigid members are pivotably coupled together (e.g., at the hinge).

In particular embodiments, shut-off can be achieved by pivoting the tubular members relative to one another to fold the kink tube on itself. This can cause the walls of the kink tube flatten and press against each other to create a seal in the fold area. To achieve more efficient sealing, various constructions can be applied to the kink tube to facilitate sealing at a given angulation. For example, in some embodiments, the kink tube's walls can be constructed so that they are thinner and/or more easily collapsible in the area where folding occurs. The kink tube's cross-section can, for example, be shaped such that it folds and/or seals more easily where it passes through the pivot area of the rigid members.

In some embodiments, one or more of the rigid members can include a magnet mount portion. The magnet mount portion can be used to secure a drink tube assembly to another object (e.g., a strap of a pack). In such embodiments, the magnet mount can be designed such that its orientation relative to the kink valve/shut-off assembly is adjustable. An adjustable magnet mount can, for example, comprise a collar mounted over one of the rigid members that can be rotated around the rigid member such that the magnet faces a particular direction. In some embodiments, the collar and the rigid member to which the collar is attached can be indexed (e.g., feature points of increased frictional interference), thereby allowing the collar to be fixed in various positions.

In other embodiments, the magnet mount can be built into one of the rigid members and can employ a hinge that can be uncoupled so that the rigid member with magnet can detached from another first tubular member and then rotated to the desired orientation before being re-assembled.

In one representative embodiment, a kink valve assembly comprises a first rigid member, a second rigid member pivotably coupled to the first rigid member, an elongate, flexible kink tube having first and second end portions, wherein the kink tube extends though the first and the second rigid members, a mouthpiece coupled to the first end portion of the kink tube, a first lock portion coupled to the first rigid member, a second lock portion coupled to the second rigid member, wherein the second lock portion is configured to releasably engage the first lock portion such that the first and the second rigid members cannot pivot relative to each other, and an actuator coupled to the first rigid portion or the second rigid portion, wherein the actuator is configured control the engagement of the first and the second lock portions.

In some embodiments, the first and the second rigid members are pivotable relative to each other from a first position to a second position and from the second position to the first position, and the kink tube is in an open configuration in the first position and in a sealed configuration in the second position. In some of those embodiments, the first lock portion is disengaged from the second lock portion in the first position, and the first lock portion is engaged with the second lock portion in the second position. In some of those embodiments, the actuator is configured such that actuating the actuator causes the second lock portion to disengage from the first lock portion.

In some embodiments, the first lock portion is integrally formed with the first rigid member, and the second lock portion is integrally formed with the second rigid member. In some embodiments, the actuator is movably coupled to the second rigid member. In some of those embodiments, the kink valve assembly further comprises a biasing element configured to bias the positioning of the actuator relative to the second rigid member. In some of those embodiments, the biasing element is disposed in a housing portion of the second rigid member.

In some embodiments, the mouthpiece comprises a bite valve. In some embodiments, the second end portion of the kink tube is coupled to a drink tube of a hydration bladder.

In another representative embodiment, a kink valve assembly comprises a first rigid member having a first lock portion, a second rigid member pivotably coupled to the first rigid member, an elongate kink tube extending though the first and the second rigid members, a mouthpiece coupled to one end of the kink tube, and an actuator having a second lock portion and coupled to the second rigid member, wherein the second lock portion of the actuator is configured to releasably engage the first lock portion of the first rigid member such that the first and the second rigid members cannot pivot relative to each other and fluid is prevented from flowing through the kink tube to the mouthpiece.

In some embodiments, the first and the second rigid members are pivotable between a first position and a second position, the kink tube being in an open configuration in the first position and in a closed configuration in the second position. In some of those embodiments, the first lock portion of the first rigid member is disengaged from the second lock portion of the actuator in the first position, and the first lock portion of the first rigid member is engaged with the second lock portion of the actuator in the second position.

In some embodiments, the actuator is configured such that actuating the actuator causes the second lock portion of the actuator to disengage the first lock portion of the first rigid member. In some embodiments, the actuator is slidably coupled to the second rigid member. In some embodiments, the actuator is coupled to a spring that biases the second lock portion of the actuator toward a locked configuration.

In some embodiments, the first and the second rigid members are pivotable relative to each other to a plurality of indexed positions in which the first and the second rigid members resist pivoting relative to each other. In some embodiments, the first lock portion comprises a loop having a laterally extending opening, the second lock portion comprises a radially extending projection, and the projection of the second lock portion is configured to extend into the opening in the first lock portion to releasably engage the loop of the first lock portion.

In another representative embodiment, a hydration assembly comprises a bladder having a drink tube, a pack configured for holding the bladder, and a kink valve coupled to the drink tube of the bladder, the kink valve including a first rigid member having a first lock portion, a second rigid member pivotably coupled to the first rigid member, an elongate kink tube extending though the first and the second rigid members, a mouthpiece coupled to one end of the kink tube, and an actuator having a second lock portion and coupled to the second rigid member, wherein the second lock portion of the actuator is configured to releasably engage the first lock portion of the first rigid member such that the first and the second rigid members cannot pivot relative to each other and fluid is prevented from flowing through the kink tube to the mouthpiece.

In some embodiments, the drink tube of the bladder and the kink tube of the kink valve are integrally formed.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 shows an exemplary backpack hydration system.

FIG. 2 shows a cyclist wearing a hydration backpack.

FIG. 3 is a side view of a kink valve assembly, according to one embodiment.

FIG. 4 is a perspective view of the kink valve assembly of FIG. 3.

FIG. 5 is an exploded view of the kink valve assembly of FIG. 3.

FIG. 6 shows the kink valve assembly of FIG. 3 in a folded position.

FIGS. 7A-7B show the kink valve assembly of FIG. 3 attached to a drink tube, in unfolded and folded positions, respectively.

FIG. 7C shows the kink valve assembly of FIG. 3 attached to a drink tube and with an optional kink valve assembly cover.

FIGS. 8A-8B are various views of a kink valve assembly, according to another embodiment.

FIGS. 9-14 are various views of a kink valve assembly, according to another embodiment.

FIGS. 15-17 are various views of a kink valve assembly, according to another embodiment.

FIGS. 18-20 are various views of a kink valve assembly, according to another embodiment.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatuses, and systems are not limited to any specific aspect or feature or combination thereof, nor do the disclosed embodiments require that any one or more specific advantages be present or problems be solved.

Integers, characteristics, materials, and other features described in conjunction with a particular aspect, embodiment, or example of the disclosed technology are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosed technology is not restricted to the details of any foregoing embodiments. The disclosure extends to any novel one, or any novel combination, of the features disclosed in this specification (including any accompanying claims, abstract and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element. As used herein, the term “and/or” used between the last two of a list of elements means any one or more of the listed elements. For example, the phrase “A, B, and/or C” means “A”, “B,”, “C”, “A and B”, “A and C”, “B and C”, or “A, B, and C.”

As used herein, the term “coupled” generally means physically coupled or linked and does not exclude the presence of intermediate elements between the coupled items absent specific contrary language.

Described herein are embodiments of kink valves and kink valve assemblies. In some embodiments, the kink valves can be used in a hydration assembly, such as a hydration pack. In some embodiments, the kink valve assembly can include a foldable kink tube fluidly coupled to a bite valve and/or a drink tube of a hydration assembly. The kink tube can be opened to allow fluid flow and can be folded to seal off flow of the fluid. In some embodiments, in the open position, the kink tube largely maintains its cross-sectional area; while in the folded position, the kink tube's collapsed walls press against one another to create a seal sufficient to withstand pressure levels to which a hydration system might be subjected. Therefore, fluid flow is not hampered by the kink tube when the kink valve assembly is in the open position, while shut-off is easily and reliably achieved.

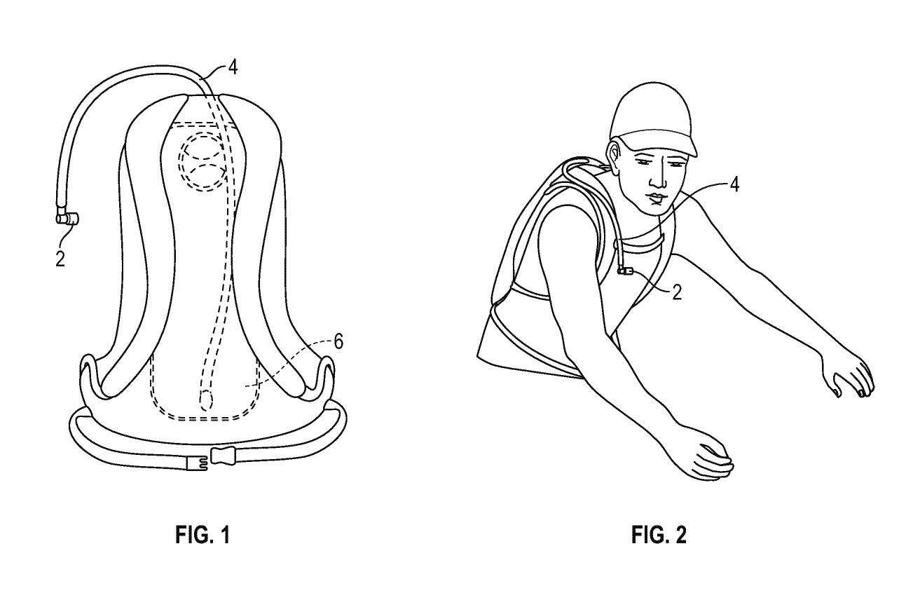

FIG. 1 shows an example of a backpack-based hydration assembly featuring a bite valve 2 attached to the end of drink tube 4, which is connected to internal reservoir 6. FIG. 2 illustrates, for example, an over-the-shoulder routing of a drink tube 4 for a hydration pack-wearing cyclist.

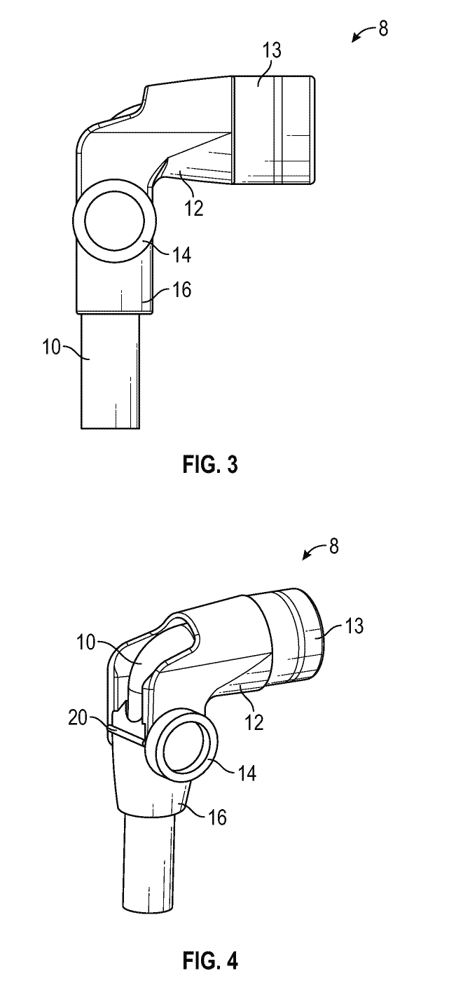

FIGS. 3-6 show an exemplary kink valve assembly 8, according to one embodiment. Referring to FIGS. 3-4, the kink valve assembly 8 can comprise a flexible kink tube 10, a first rigid member 12, and a second rigid member 16. The kink tube 10 can be disposed within and extend through the first rigid member 12 and the second rigid member 16, and the first and the second rigid members 12, 16 can be pivotably coupled together, as further described below.

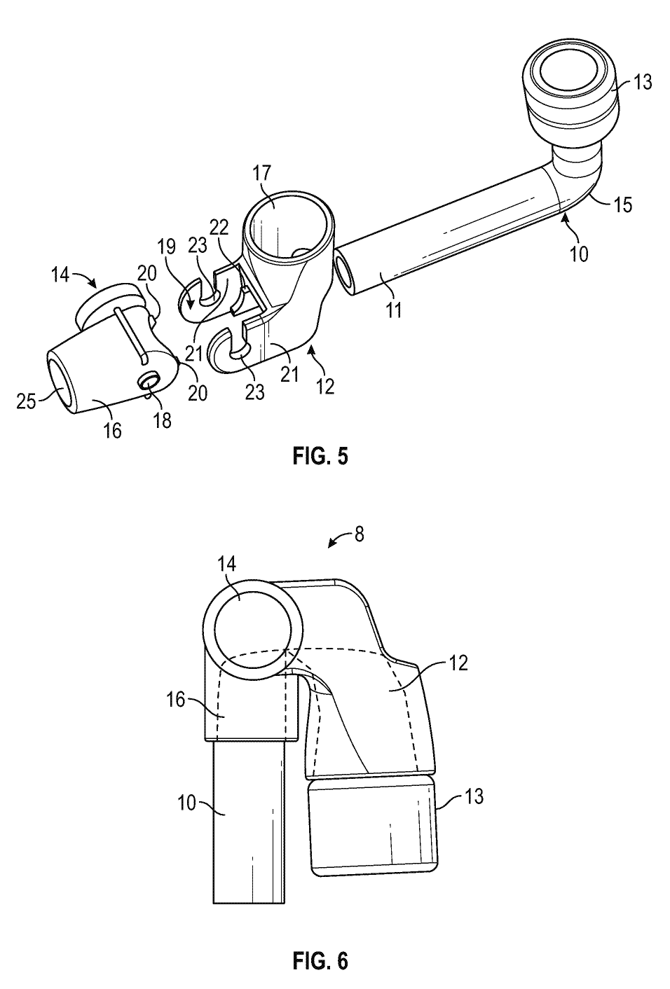

Referring to FIG. 5, the kink tube 10 can include a main tube portion 11 and a mouthpiece portion 13. As shown, the main tube portion 11 and the mouthpiece 13 can, for example, be integrally formed as a single, unitary piece. In other embodiments, the main tube portion 11 and the mouthpiece 13 can be formed as separate pieces that are coupled together. As also shown, the kink tube 10 can, for example, be pre-formed in an angled configured (i.e., the mouthpiece portion 13 can be axially angled relative to the main tube portion 11). In such embodiments, the kink tube 10 can have an angled portion 15 pre-formed at a desired angle (e.g., 30°, 45°, 90°, 110°, etc.). In other embodiments, the kink tube 10 can be pre-formed in a straight configuration (i.e., the mouthpiece portion 13 can be axially aligned relative to the main tube portion 11).

Referring still to FIG. 5, the first rigid member 12 can include an annular portion 17 and a bracket portion 19. The annular portion 17 of the first rigid member 12 can be configured such that at least a portion of the kink tube 10 (e.g., the main tube portion 11 and/or the mouthpiece portion 13 of the kink tube 10) can extend into and/or through the annular portion 17. The bracket portion 19 of the first rigid member 12 can be configured to pivotably couple the first rigid member to the second rigid member (or other rigid member), as further described below. The bracket portion 19 can include one or more tabs 21 (two in the illustrated embodiment) that axially extend from the annular portion 17. The tabs 21 can include one or more openings and/or grooves 23 (two in the illustrated embodiment) which can be configured to pivotoably receive a portion of the second rigid member 16.

The first rigid member 12 can, optionally, include one or more notches 22 that are configured to engage, for example, ribs or projections 20 of the second rigid member 16.

The second rigid member 16 can include annular portion 25 and a pivot element 18. The annular portion 25 of the second rigid member 16 can be configured such that at least a portion of the kink tube 10 (e.g., the main tube portion 11 and/or the mouthpiece portion 13 of the kink tube 10) can extend into and/or through the annular portion 25. The pivot element 18 can, for example, be a pin and/or projection extending through and/or from the annular portion 25.

The second rigid member 16 can, optionally, include a magnet mount portion 14 and one ribs or projections 20. The magnet mount portion 14 and/or the ribs 20 can be coupled to and/or extend from the annular portion 25. The magnet mount portion 14 can be configured to securely receive a magnetic element (not shown). The magnetic element can be used to releasably secure the kink valve assembly 8 to, for example, a strap of a hydration pack (see, e.g., FIG. 1) and/or a garment.

It should be noted that at least some of the features of the first and the second rigid member 12, 16 are interchangeable. For example, in alternative embodiments, the first rigid member 12 can include a pivot element, and the second rigid member 16 can include a bracket portion configured to pivotably receive the pivot element of the first rigid member 12. In other embodiments, for example, the first rigid member 12 can include one or more ribs, and the second rigid member 16 can include one or more notched configured to engage the ribs of the first rigid member 12.

Referring FIGS. 4 and 5, the kink valve assembly 8 can be assembled, for example, by inserting the pivot element 18 of the second rigid member 16 into the grooves 23 of the first rigid member 12, thereby pivotably coupling the first and second rigid members 12, 16 such that the first and second rigid members can pivot relative to each other about the pivot element 18 of the second rigid member 18. The second rigid member 16 can be assembled with the first rigid member 12 so that magnet mount 14 is directed to one side of the first rigid member 12 or to another other side of the first rigid member 12. The kink tube 10 can be coupled to the first and second rigid member 12, 16 by inserting the main tube portion 11 of the kink tube 10 through the respective annular portions 17, 25 of the first and second rigid member 12, 16.

As noted above, the notches 22 of the first rigid member 12 can be configured to engage the ribs or projections 20 of the second rigid member 16. As such, the notches 22 and the ribs 20 can interact to provide indexing between the first and second rigid members 12, 16 when the first and second rigid members 12, 16 are pivoted relative to each other. For example, in the illustrated embodiment, the kink valve assembly 8 indexed positions include an open configuration in which the mouthpiece portion 13 of the kink tube 10 is offset relative to the main tube portion 11 of the kink tube by about 90 degrees (e.g., FIGS. 3-4) and a closed configuration in which the mouthpiece portion 13 of the kink tube 10 is offset relative to the main tube portion 11 of the kink tube by about 180 degrees (e.g., FIG. 6).

In some embodiments, the kink valve assembly 8 can include one or more other indexed positions, in lieu of or in addition to an open and a closed configuration. For example, the kink valve assembly 8 can include a fully closed indexed position, a fully open indexed position, and one or more indexed positions between the fully open and the fully closed positions (e.g., from about 0° to about 180°). In some embodiments, the first and second rigid members 12, 16 can be pivoted relative to each other in either and/or both directions (e.g., clockwise and/or counterclockwise).

FIG. 4 shows the kink valve assembly 8 in an open configuration. In the open configuration, the first and the second rigid member 12, 16 are positioned relative to each other such that the kink tube 10 is in its pre-formed state, thus allowing fluid to flow through the kink tube 10. The first and second rigid members 12, 16 can be pivoted relative to each other from the open configuration (or any other configuration) to a closed configuration, as shown in FIG. 6.

In the closed configuration, a portion of the kink tube 10 (e.g., a portion kink tube 10 at or near the pivot point between the first and second rigid member 12, 16) can kink and collapse upon itself. The collapsed portion of the kink tube 10 can press sufficiently firmly together to form a seal, thereby preventing fluid from flowing through the kink tube 10.

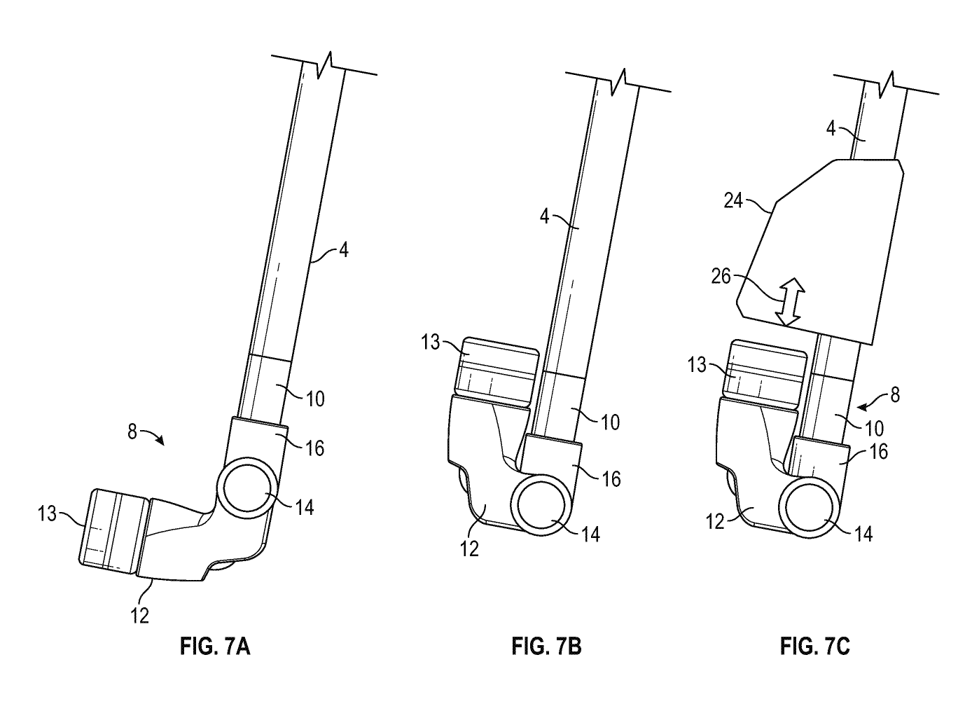

FIGS. 7A-7C show the kink valve assembly 8 attached to a drink tube 4, which can be connect to a fluid reservoir (not shown). As shown in the illustrated embodiment, the drink tube 4 and the kink tube 10 can, for example, be formed as separate pieces which are connected or coupled together. In other embodiments, the drink tube 4 and the kink tube 10 can, for example, be formed as a single, continuous tube. FIG. 7A shows the kink valve assembly 8 in the open position, and FIG. 7B shows the kink valve assembly 8 in the closed position.

FIG. 7C shows an optional kink valve assembly cover 24 which can, for example, be adjustably (e.g., slidably) mounted on the drink tube 4. The cover 24 can be moved relative to the drink tube 4 and the kink valve assembly 8 by sliding the cover 24 along the drink tube 4 and/or the kink tube 10 (e.g., in the directions shown by arrow 26. The cover 24 can be configured so that the cover 24 can slide over at least a portion (e.g., the mouthpiece 13) of the kink valve assembly 8 to protect the kink valve assembly from debris. The cover 24 can also be configured to slide over at least a portion (e.g., the first and the second rigid members 12, 16) of the kink valve assembly 8, thereby preventing the kink valve assembly 8 from being inadvertently moved from a desired configuration to another configuration (e.g., from the closed configuration to the open configuration, or vice versa).

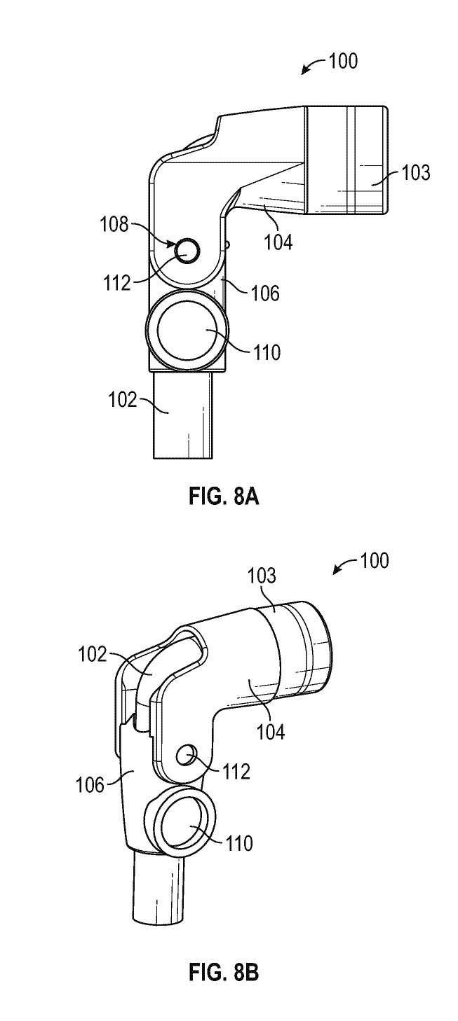

FIGS. 8A-8B show an example of a kink valve assembly 100, according to another embodiment. The kink valve assembly 100 can comprise a kink tube 102, a first rigid member 104, and a second rigid member 106. The kink valve assembly 100 can have a mouthpiece 103 and can be configured similar to the kink valve assembly 8.

Referring to FIG. 8A, the first rigid member 104 can include one or more openings 108 (e.g., one on each side of the first rigid member 104 in the illustrated embodiment). The openings 108 can, for example, be configured to pivotably and/or rotatably connect the first rigid member 104 to the second rigid member 106, as further described below.

The second rigid member 106 can include a magnet mount portion 110 and one or more pivot elements or pins 112 (e.g., one on each side of the second rigid member 106 in the illustrated embodiment). The magnet mount portion 110 can be configured to securely received a magnet element (not shown) which can, for example, be used to secure the kink valve assembly 100 and/or a drink tube (not shown) to a portion of a hydration pack and/or garment. The pivot elements 112 can be configured to extend into and/or through the openings 108 of the first rigid member 104, thereby pivotably and/or rotatably connecting the first and the second rigid members 104, 106. As such, the first and the second rigid members 104, 106 can pivot relative to each other to actuate (e.g., open or close) the kink tube 102 in a manner similar to the kink valve assembly 10 (see, e.g., FIGS. 4 and 6).

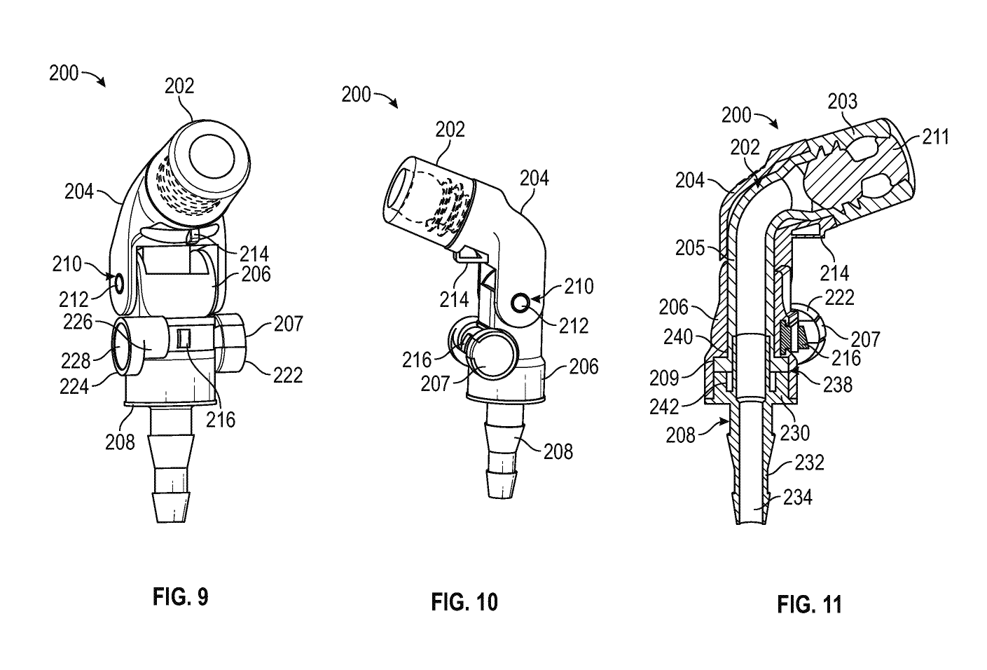

FIGS. 9-14 show an example of a kink valve assembly 200, according to another embodiment. Referring to FIG. 10, the kink valve assembly 200 can comprise a kink tube 202, a first rigid member 204, a second rigid member 206, an actuator 207, and a fluid supply connecting member 208. As best shown in FIG. 11, the kink tube 202 can be coupled to and extend through the first and second rigid members 204, 206. The actuator 207 can be adjustably coupled to the second rigid member 206. The fluid supply connecting member 208 can be coupled to and extend into the second rigid member 206 and the kink tube 202.

Referring to FIG. 11, the kink tube 202 can include a mouthpiece portion 203 (e.g., having an optional bite valve insert 211), a main tube portion 205, and a flange portion 209. The mouthpiece portion 203 can be disposed at one end portion of the main tube portion 205, and the flange portion 209 can be disposed the other end portion of the main tube portion 205, opposite the mouthpiece 203.

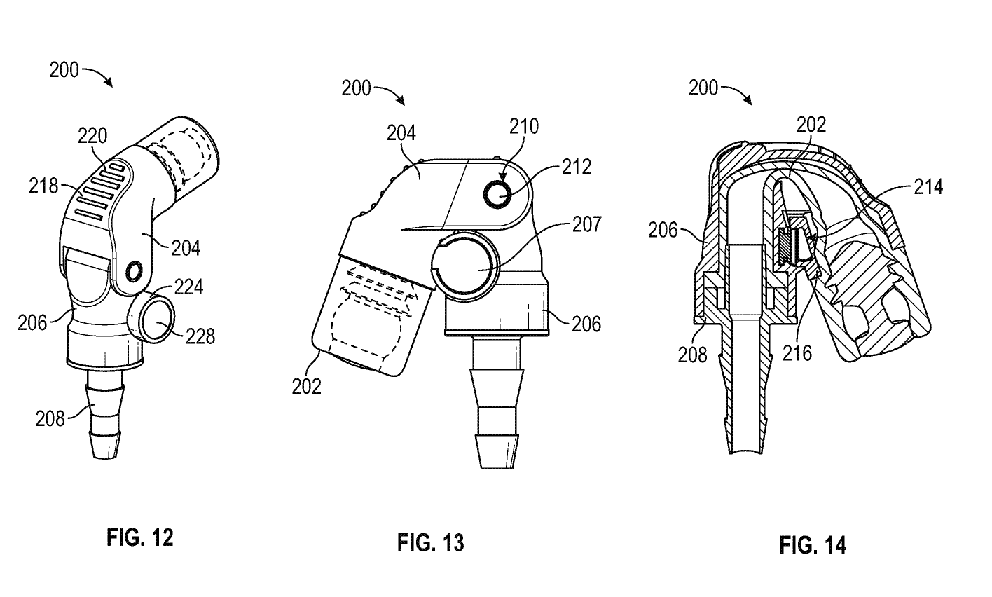

Referring to FIGS. 9-12, the first rigid member 204 can include one or more pivot receptacles 210 (e.g., two in the illustrated embodiment), a first lock portion 214, and a grip portion 218 (FIG. 12). In the illustrated embodiment, the pivot receptacles 210 can, for example, be openings which extend laterally through the first rigid member. In other embodiments, the pivot receptacles can be detents formed in a radially inwardly facing portion of the first rigid member. The pivot receptacles 210 can be configured to pivotably and/or rotatably couple the first rigid member 204 to a pivot element 212 of the second rigid member 206.

As best shown in FIGS. 10 and 11, the first rigid member 204 can also include a first lock portion 214. In some embodiments, the first lock portion 214 can be integrally formed with the first rigid member 204. In other embodiments, the first lock portion 214 can be formed separately and securely coupled to the first rigid member 204 (e.g., with an adhesive, fasteners, etc.). The lock portion 214 can, for example, be formed as a loop with a laterally extending opening. In this manner, the first lock portion 214 can be configured to releasably receive a second lock portion 216 of the actuator 207, as further described below.

Referring to FIG. 12, the grip portion 218 of the first rigid member 204 can have a textured surface (e.g., having ribs 220) which can, for example, improve a user's grip on the first rigid member 204 when pivoting the first rigid member 204 relative to the second rigid member 206 to open and/or close the kink tube 202. For example, as shown, the grip portion 218 can include ribs 220 to improve the user's grip. In other embodiments, the grip portion 218 can have various other textured surfaces, including one or more recesses, a coating, etc. which can improve the user's grip.

Referring to FIG. 9, the second rigid portion 206 can include an actuator mounting portion 222, a magnet mounting portion 224, and a housing portion 226. The actuator mounting portion 222 can be configured to adjustably (e.g., slidably) receive the actuator 207. The magnet mounting portion 224 can be configured to securely receive a magnet 228 which can be used to releasably secure the kink valve assembly 200 to, for example, a strap of a pack comprising another magnet of opposite polarity (not shown) relative to the magnet 228.

The housing portion 226 of the second rigid portion 206 can be configured to adjustably (e.g., slidably) receive a portion of the actuator 207. The housing portion 226 can also be configured to receive a biasing element (e.g., a spring) which biases the actuator 207 to a particular positioning or configuration relative to the second rigid portion 206. For example, the biasing element can bias the actuator 207 to a first position (e.g., a locked position) relative to the second rigid member 206, and the actuator 207 can be depressed (e.g., by a user) with sufficient force to overcome the bias of the biasing element, thereby moving the actuator 207 from the first position (e.g., the locked position) to a second position (e.g., an unlocked position) relative to the second rigid member 206. When the depressing force is removed from the actuator 207, the actuator 207 returns to the first position from the second position due to the bias of the biasing element. In this manner, the actuator 207 moves in an axis that is transverse to the main tube portion 205 of the kink tube 202 and in an axis that is parallel to the pivot axis of the first and second rigid members.

As noted above and best shown in FIGS. 9-11, the actuator 207 can include a second lock portion 216. The second lock portion 216 of the actuator 207 can be configured to releasably mate with the first lock portion 214 of the first rigid member 204. For example, as shown, the first lock portion 214 of the first rigid member 204 can be a female lock portion comprising an opening or detent for releasably receiving a male second lock portion 216 of the actuator 207. In other embodiments, the first lock portion 214 can, for example, be a male lock portion and the second lock portion 216 can be a female lock portion.

In this manner, the first lock portion 214 of the first rigid member 204 and second lock portion 216 of the actuator 207 can be configured to releasably engage with each other in a mated configuration to secure the positioning of the first rigid member 204 relative to the second rigid member. For example, as best shown in FIG. 14, the second lock portion 216 of the actuator 207 can be configured to engage the first lock portion 214 of the first rigid member 204 when the first rigid member 204 and/or the second rigid member 206 are rotated to a closed configuration (i.e., a configuration in which the kink tube 202 is closed from flow). The second lock portion 206 engages the first lock portion 214 by extending into the opening of the first lock portion. The biasing element presses against the actuator 207 to ensure that second lock portion 206 remains engaged with the first lock portion 214. As a result, the actuator 207 prevents the first rigid member 204 from inadvertently rotating relative to the second rigid member 206, and thus ensures that the kink tube 202 remains closed.

The first rigid member 204 can be released from actuator 207 by depressing the actuator 207, which causes the actuator 207 to slide relative to the first and second rigid members 204, 206. As a result, the second lock portion 216 of the actuator 207 disengages the first lock portion 214 of the first rigid member 204, thereby allowing the first rigid member 204 to rotate relative to the second rigid member 206. Accordingly, the kink tube 202 moves from the closed configuration (e.g., FIGS. 13-14) to an open configuration (e.g., FIGS. 9-12).

Referring to FIG. 11, the fluid supply connecting member 208 can have a first fitting portion 230, a second fitting portion 232, and an internal channel portion 234. The first fitting portion 230 can be coupled to and extend into the kink tube 202 and/or the second rigid member 206. The second fitting portion 232 can be disposed opposite from the first fitting portion 230 can be used, for example, to connect the fluid supply connecting member 208, and thus the kink tube, to a fluid source (e.g., to a bladder via a drink tube of a hydration pack). The second fitting can, for example, be a barb fitting, as shown in the illustrated embodiment. The internal channel portion 234 can extend through the fluid supply connecting member 208, thereby allowing a fluid to flow through the fluid supply connecting member 208 and into the kink tube 202.

Referring still to FIG. 11, The flange portion 209 of the kink tube 202 can be disposed in an annular recess 238 defined by shoulders 240, 242 of the second rigid member 206 and the fluid supply connecting member 208, respectively. The flange 209 can engage the shoulders 240, 242, and thus removably secure the kink tube 202 within the kink valve assembly 200.

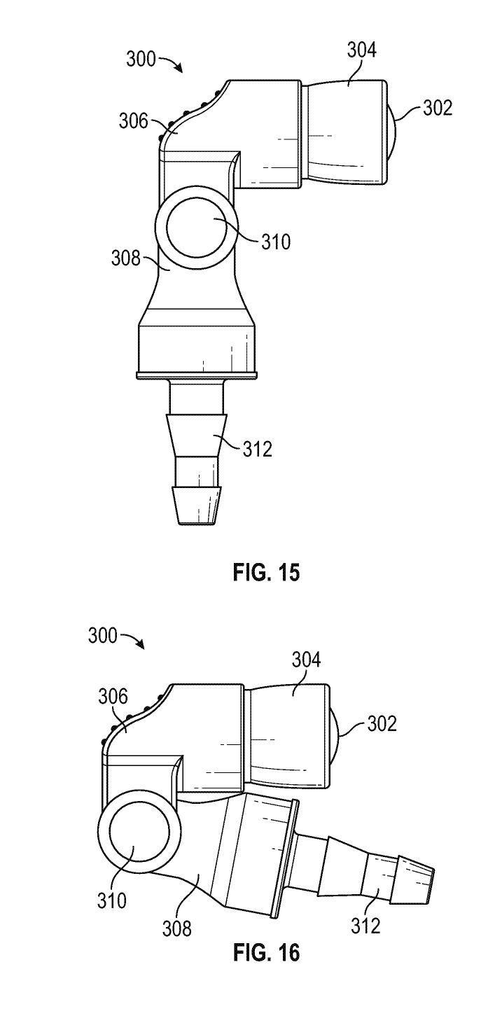

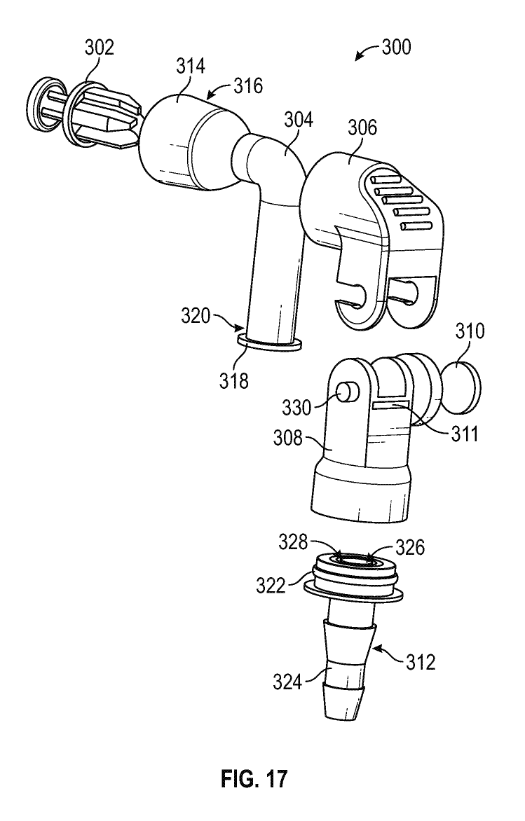

FIGS. 15-17 show an example of a kink valve assembly 300, according to another embodiment. Referring to FIG. 17, the kink valve assembly 300 can comprise a bite valve insert or stem 302, a kink tube 304, a first rigid portion 306, a second rigid portion 308, a magnet 310, and a connecting member 312. The kink valve assembly 300 can be configured similar to the kink valve assembly 8.

Referring still to FIG. 17, the kink tube 304 can have a mouthpiece portion 314 at a first end portion 316 of the kink tube 304 and a flange portion 318 at a second end portion 320 of the kink tube 304. The second end portion 320 of the kink tube 304 can be inserted through the first and the second rigid members 306, 308 and can be inserted into and coupled to the connecting member 312.

The connecting member 312 can include a first fitting portion 322, a second fitting portion 324 opposite the first fitting 322, and an internal channel 326 which extends through the connecting member 312. The first fitting portion 322 of the connecting member 312 can be coupled to the second rigid member 308, for example, via an adhesive and/or a snap-fit type connection. The first fitting portion 322 can have an annular recess or groove 328 configured to securely receive the flange portion 318 of the kink tube 304.

The second fitting portion 324 can be configured to be coupled to, for example, a drink tube of a hydration pack. As shown, the second fitting portion 324 can, for example, be a barb fitting.

The kink valve assembly 300 can be configured such that the first rigid member 306 can pivot about pivot elements 330 of the second rigid member 308. In this manner, as shown in FIGS. 15-16, the kink valve assembly 300 can pivot from an open configuration in which fluid can flow through the kink tube 304 (FIG. 15) to a closed configuration in which fluid cannot flow through the kink valve 304 (FIG. 16), and vice versa.

The first and second rigid members 306, 308 can configured with various locking elements that can prevent the first and the second rigid members 306, 308 from rotating relative to each other. For example, as shown in FIG. 17, the second rigid member 308 can include at least one rib 331 which is configured to engage at least one notch or ridge (not shown) on the first rigid member 306 in a manner that can retain the selectively retain the relative positioning first and the second rigid members 306, 308. The ribs 331 and notches can be configured to provide a plurality of indexed relative configurations between the first and second rigid members 306, 308 (e.g., open and/or closed configurations). In other embodiments, the kink valve assembly 300 can, for example, include a locking mechanism similar to the kink valve assembly 200.

In some embodiments, the second rigid member 308 can include a magnet mounting portion 332 configured to securely receive the magnet 310. In a particular embodiment, the magnet mounting portion 332 can be disposed on the second rigid member 308 coaxial to the pivot element 330.

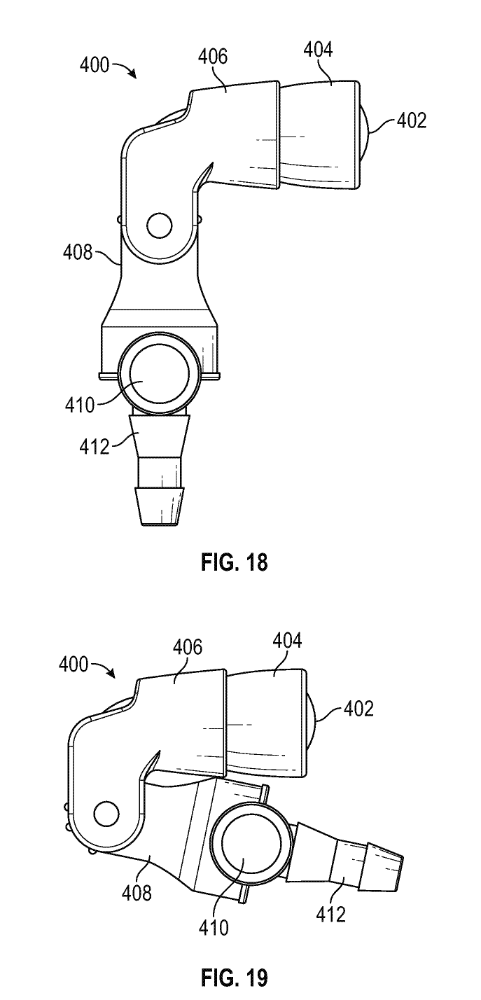

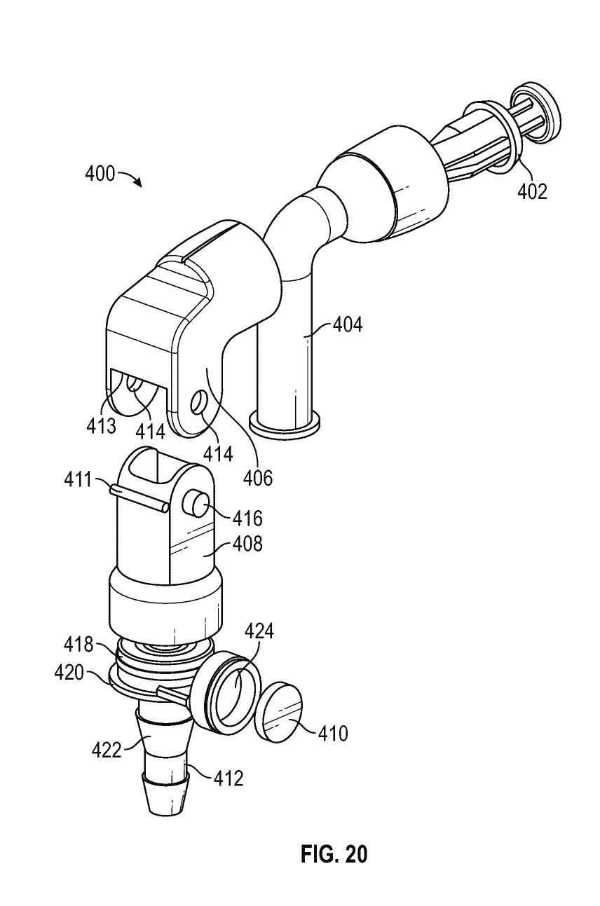

FIGS. 18-20 show an example of a kink valve assembly 400, according to another embodiment. Referring to FIG. 20, the kink valve assembly 400 can comprise a bite valve insert 402, a kink tube 404, a first rigid portion 406, a second rigid portion 408, a magnet 410, and a connecting member 412. The kink valve assembly 400 can be configured similar to the kink valve assembly 300.

The first and second rigid members 406, 408 can be pivotably connected relative to each other via pivot openings 414 in the first rigid member 406 configured to receive respective pivot elements 416 of the second rigid 408. In this manner, as shown in FIGS. 18-19, the kink valve assembly 400 can pivot from an open configuration in which fluid can flow through the kink tube 404 (FIG. 17) to a closed configuration in which fluid cannot flow through the kink valve 404 (FIG. 18), and vice versa.

In some embodiments, for example, the connection between the first and second rigid members 406, 408 can be indexed such that the first and second rigid members 406, 408 can be incrementally rotated relative each other in predefined steps (e.g., 15°, 30°, 45°, 90°, 180°, etc.) This can, for example, advantageously allow a user to customize and/or lock the positioning of the kink valve assembly 400. This can also advantageously allow the kink valve 400 to be adapted various applications (e.g., backpacks, waistpacks, bottles, etc.)

This can be accomplished for example, by providing ribs and corresponding ridges that can engage each other. For example, referring to FIG. 11, the second rigid member 408 can include at least one rib 411 which is configured to engage a ridge 413 of the first rigid member 406 in a manner which can lock the positioning of the first and second rigid members 406, 408 relative to each other.

Referring again to FIG. 20, the connecting member 412 can include a first fitting portion 418, a flange portion 420, a second fitting portion 422, and a magnet mounting portion 424. The flange portion 420 can be disposed between the first and second fittings 418, 422, and the magnet mounting portion 422 can be connected to and extend laterally from the flange portion 420.

The connecting member 412 can be rotatably coupled to the second rigid member 408. As such, the connecting member 412, and thus the magnet mounting portion 424, can be circumferentially oriented relative to the second rigid member 408 as desired. In some embodiments, for example, the connection between the connecting member 412 and the second rigid member 408 can be indexed such that the connecting member can be incrementally rotated relative to the second rigid member 408 in predefined steps (e.g., 15°, 30°, 45°, 90°, 180°, etc.) This can, for example, advantageously allow a user to customize the positioning of the kink valve assembly 400 based on preference. This can also advantageously allow the kink valve 400 to be adapted various applications (e.g., backpacks, waistpacks, bottles, etc.).

Although not shown, this can be accomplish, for example, by forming an interior portion of the second rigid member 408 with a plurality of internal teeth and by forming an exterior portion of the fluid supply connecting member 412 with a plurality of external teeth that are correspond to the internal teeth of the second rigid member 408 (e.g., in a ratcheting type action).

Although not shown, the connecting member 412 can also include an internal channel (not shown) extending through the connecting member 412.

It should be noted that magnets and magnet mounting portions are used as examples of fasteners that can be used to secure a kink valve assembly. In some embodiments, various other types of fasteners such as hook-and-loop fasteners (e.g., Velcro®), buttons, etc. can be used to releasably secure a kink valve assembly.

In view of the many possible embodiments to which the principles of the disclosed technology may be applied, it should be recognized that the illustrated embodiments are only preferred examples and should not be taken as limiting the scope of the disclosure.

1. A kink valve assembly, comprising:
a first rigid member;
a second rigid member pivotably coupled to the first rigid member;
an elongate, flexible kink tube having first and second end portions, wherein the kink tube extends though the first and the second rigid members;
a mouthpiece coupled to the first end portion of the kink tube;
a first lock portion coupled to the first rigid member;
a second lock portion coupled to the second rigid member, wherein the second lock portion is configured to releasably engage the first lock portion such that the first and the second rigid members cannot pivot relative to each other; and
an actuator coupled to the first rigid portion or the second rigid portion, wherein the actuator is configured control the engagement of the first and the second lock portions.

2. The assembly of claim 1, wherein the first and the second rigid members are pivotable relative to each other from a first position to a second position and from the second position to the first position, and the kink tube is in an open configuration in the first position and in a sealed configuration in the second position.

3. The assembly of claim 2, wherein the first lock portion is disengaged from the second lock portion in the first position, and the first lock portion is engaged with the second lock portion in the second position.

4. The assembly of claim 3, wherein the actuator is configured such that actuating the actuator causes the second lock portion to disengage from the first lock portion.

5. The assembly of claim 1, wherein the first lock portion is integrally formed with the first rigid member, and the second lock portion is integrally formed with the second rigid member.

6. The assembly of claim 1, wherein the actuator is movably coupled to the second rigid member.

7. The assembly of claim 6, further comprising a biasing element configured to bias the positioning of the actuator relative to the second rigid member.

8. The assembly of claim 7, wherein the biasing element is disposed in a housing portion of the second rigid member.

9. The assembly of claim 1, wherein the mouthpiece comprises a bite valve.

10. The assembly of claim 1, wherein the second end portion of the kink tube is coupled to a drink tube of a hydration bladder.

11. A kink valve assembly, comprising:
a first rigid member having a first lock portion;
a second rigid member pivotably coupled to the first rigid member;
an elongate kink tube extending though the first and the second rigid members;
a mouthpiece coupled to one end of the kink tube; and
an actuator having a second lock portion and coupled to the second rigid member, wherein the second lock portion of the actuator is configured to releasably engage the first lock portion of the first rigid member such that the first and the second rigid members cannot pivot relative to each other and fluid is prevented from flowing through the kink tube to the mouthpiece.

12. The assembly of claim 11, wherein the first and the second rigid members are pivotable between a first position and a second position, the kink tube being in an open configuration in the first position and in a closed configuration in the second position.

13. The assembly of claim 12, wherein the first lock portion of the first rigid member is disengaged from the second lock portion of the actuator in the first position, and the first lock portion of the first rigid member is engaged with the second lock portion of the actuator in the second position.

14. The assembly of claim 11, wherein the actuator is configured such that actuating the actuator causes the second lock portion of the actuator to disengage the first lock portion of the first rigid member.

15. The assembly of claim 11, wherein the actuator is slidably coupled to the second rigid member.

16. The assembly of claim 11, wherein the actuator is coupled to a spring that biases the second lock portion of the actuator toward a locked configuration.

17. The assembly of claim 11, wherein the first and the second rigid members are pivotable relative to each other to a plurality of indexed positions in which the first and the second rigid members resist pivoting relative to each other.

18. The assembly of claim 11, wherein the first lock portion comprises a loop having a laterally extending opening, the second lock portion comprises a radially extending projection, and the projection of the second lock portion is configured to extend into the opening in the first lock portion to releasably engage the loop of the first lock portion.

19. A hydration assembly, comprising:
a bladder having a drink tube;
a pack configured for holding the bladder; and
a kink valve coupled to the drink tube of the bladder, the kink valve including:
a first rigid member having a first lock portion,
a second rigid member pivotably coupled to the first rigid member,
an elongate kink tube extending though the first and the second rigid members,
a mouthpiece coupled to one end of the kink tube, and
an actuator having a second lock portion and coupled to the second rigid member, wherein the second lock portion of the actuator is configured to releasably engage the first lock portion of the first rigid member such that the first and the second rigid members cannot pivot relative to each other and fluid is prevented from flowing through the kink tube to the mouthpiece.

20. The assembly of claim 19, wherein the drink tube of the bladder and the kink tube of the kink valve are integrally formed.
